(19) United States
(12) Patent Application Publication
(10) Pub. No.: US 2007/0154819 A1
(43) Pub. Date: Jul. 5, 2007

(54) Color filter substrate and fabricating method thereof

(76) Inventor: Chun-Lung Chen, Gueishan Shiang (TW)

Correspondence Address: J.C. Patents, Inc.;Suite 250, 4 Venture, Irvine, CA, 92618, US

(21) Appl. No.: 11/440,687

(22) Filed: May 24, 2006

(30) Foreign Application Priority Data
Dec. 30, 2005 (TW) 94147538

(51) Int. Cl. G02B 5/20

(52) U.S. Cl. 430/7

(57) ABSTRACT

A color filter substrate including a black matrix layer, a color pattern layer and an electrode layer is provided. The black matrix layer is disposed on a substrate to define a plurality of sub-pixel regions thereon. The black matrix layer has at least one identified mark. The color pattern layer is disposed on each of the sub-pixel regions, and the electrode layer is disposed on the color pattern layer and the black matrix layer.

### CROSS-REFERENCE TO RELATED APPLICATION

This application claims the priority benefit of Taiwan application serial no. 94147538, filed on Dec. 30, 2005. All disclosure of the Taiwan application is incorporated herein by reference.

### BACKGROUND OF THE INVENTION

Field of Invention

The present invention relates to a color filter substrate. More particularly, the present invention relates to a color filter substrate having an identified mark. Description of Related Art

As the increasing demand of display devices, manufacturers have been dedicated to the development of the display devices. The cathode ray tube (CRT) display has dominated the display device market for its excellent display quality and matured technology. However, recently, with the rise of the green environment protection concept that high power consumption and high radiation become disadvantageous, plus the limitation of flat panel design, the CRT display can not meet the requirements of the market trend for light, thin, short, small, beautiful, and power-saving display product. Therefore, the thin film transistor liquid crystal display (TFT-LCD), having such advantages as high image quality, high space utilization efficiency, low power consumption and no radiation, has become the mainstream product in the market.

The thin film transistor liquid crystal display module (TFT-LCD module) mainly comprises a liquid crystal display panel (LCD panel) and a back light module. Wherein, the LCD panel usually comprises a thin film transistor array substrate, a color filter substrate, and a liquid crystal layer disposed between the two substrates, wherein the back light module is suitable to provide the plane light source for the liquid crystal display panel so that the liquid crystal display module can display.

For the color filter substrate, in order to distinguish the color filter substrates made by different factories, an identified mark is usually formed on the substrate by laser, and disposed in the blank region of the substrate. Moreover, a plurality of color filter blocks may usually be formed upon single substrate so that after the color filter substrate and the thin film transistor array substrate are arranged in opposite, a plurality of liquid crystal display panels can be formed by cutting process. It should be noted that the originally formed identified mark will not exist in the cut color filter substrate; therefore, the thin film transistor array substrate usually still needs to form an identified mark thereon by laser to indicate the source of the color filter substrate. However, the identified mark can also be formed on each color filter block by laser. Regardless which method is used, the cost and labor hours will be increased. In addition, the worker still needs to input the identified mark into a computer to check the corresponding manufacturer of the color filter substrate; thus, the time for identifying the color filter substrate is still increased.

### SUMMARY OF THE INVENTION

Accordingly, the present invention is directed to provide a color filter substrate, which has an identified mark for identifying the manufacturer or product model.

Moreover, another aspect of the present invention is to provide a fabricating method of color filter substrate, so as to fabricate the color filter substrate having the identified mark.

According to the above and other aspects, the present invention provides a color filter substrate which includes a black matrix layer, a color pattern layer and an electrode layer. Wherein, the black matrix layer is disposed on a substrate to define a plurality of sub-pixel regions thereon. The black matrix layer has at least one identified mark. The color pattern layer is disposed on each of the sub-pixel regions, and the electrode layer is disposed on the color pattern layer and the black matrix layer.

According to the embodiment of the present invention, the identified mark may be a pattern, a linear barcode, a number, a text, or a symbol.

According to the embodiment of the present invention, the width of the identified mark can be smaller than the width of the black matrix layer.

According to the embodiment of the present invention, the identified mark may be a cutting angle of the black matrix layer.

According to the embodiment of the present invention, the identified mark may be disposed in the periphery of the sub-pixel regions.

According to the embodiment of the present invention, the identified mark may be disposed between the sub-pixel regions.

According to the above and other aspects, the present invention provides a fabricating method of the color filter substrate. The fabricating method of the color filter substrate includes the following processes: first, forming a black matrix layer on a substrate to define a plurality of sub-pixel regions, wherein the black matrix layer has at least an identified mark; forming a color pattern layer on each of the sub-pixel regions; then, forming an electrode layer on the substrate to cover the black matrix layer and the color pattern layer.

According to the embodiment of the present invention, the forming method of the black matrix layer includes: first, forming a black matrix material layer on the substrate; then, performing a patterning process for the black matrix material layer to form the black matrix layer.

According to the embodiment of the present invention, the patterning process may include a photolithography process and an etching process.

According to the embodiment of the present invention, the patterning process may include an exposing process and a developing process.

According to the embodiment of the present invention, the process of forming the black matrix layer may further include forming the identified mark as a pattern, a linear barcode, a number, a text, or a symbol.

According to the embodiment of the present invention, the process of forming the black matrix layer may further include forming the identified mark in the periphery of the sub-pixel regions.

According to the embodiment of the present invention, the process of forming the black matrix layer may further include forming the identified mark between the sub-pixel regions.

In summary, the present invention integrates the identified mark in the black matrix layer so that the worker can identify the manufacturer or product model of the color filter substrate by eyeballing. In addition, compared with the conventional technologies, the black matrix layer and the identified mark can be formed simultaneously by the fabricating method of color filter substrate of the present invention, so that no additional fabricating process is needed.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of the color filter substrate according to the embodiment of the present invention.

FIG. 1B is a cross-sectional diagram of the color filter substrate according to the embodiment of the present invention.

FIG. 2A-FIG. 2G are schematic diagrams of the identified mark according to the embodiment of the present invention.

FIG. 3A-FIG. 3B are schematic cross-sectional diagrams of the fabricating method of the color filter substrate according to the embodiment of the present invention.

### DESCRIPTION OF EMBODIMENTS

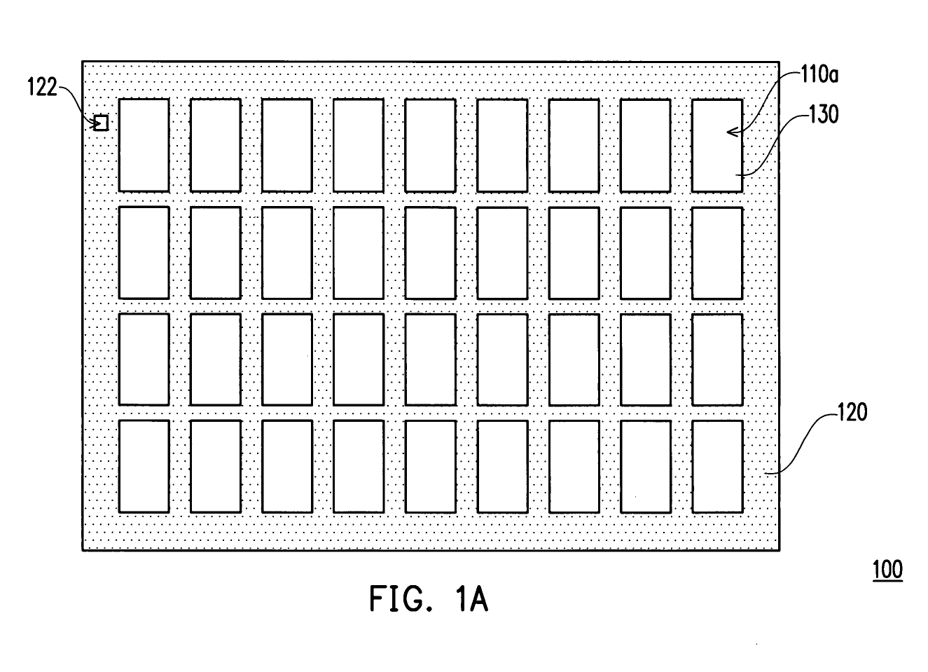

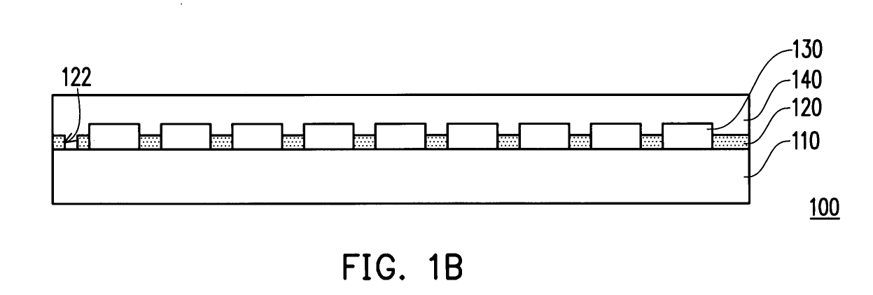

FIG. 1A is a top view of a color filter substrate according to the embodiment of the present invention, and FIG. 1B is a cross-sectional diagram of the color filter substrate according to the embodiment of the present invention. Referring to FIG. 1A and FIG. 1B, the color filter substrate 100 of the embodiment includes a black matrix layer 120, a color pattern layer 130 and an electrode layer 140. The black matrix layer 120 is disposed on a substrate 110 to define a plurality of sub-pixel regions 110a thereon. The black matrix layer 120 has at least one identified mark 122. Moreover, the color pattern layer 130 is disposed in each of the sub-pixel regions 110a, and the electrode layer 140 is disposed on the color pattern layer 130 and the black matrix layer 120.

In detail, the substrate 110 may be a glass substrate, a quartz substrate, a plastic substrate or other transparent substrates. Moreover, the material of the black matrix layer 120 may include Cr, other metal or black matrix resin. In addition, the material of the color pattern layer 130 may include color photoresist or dye, and the material of the electrode layer 140 may include indium tin oxide (ITO), indium zinc oxide (IZO), aluminum zinc oxide (AZO), or other transparent conductive materials.

It needs to be noted that the identified mark 122 may also be a pattern, linear barcode, number, text, or symbol, representing the manufacturer or product model. The identified mark 122 of the embodiment is a rectangle pattern representing the manufacturer or product model of the color filter plate. Moreover, other types of the identified mark 122 will be further described in the following.

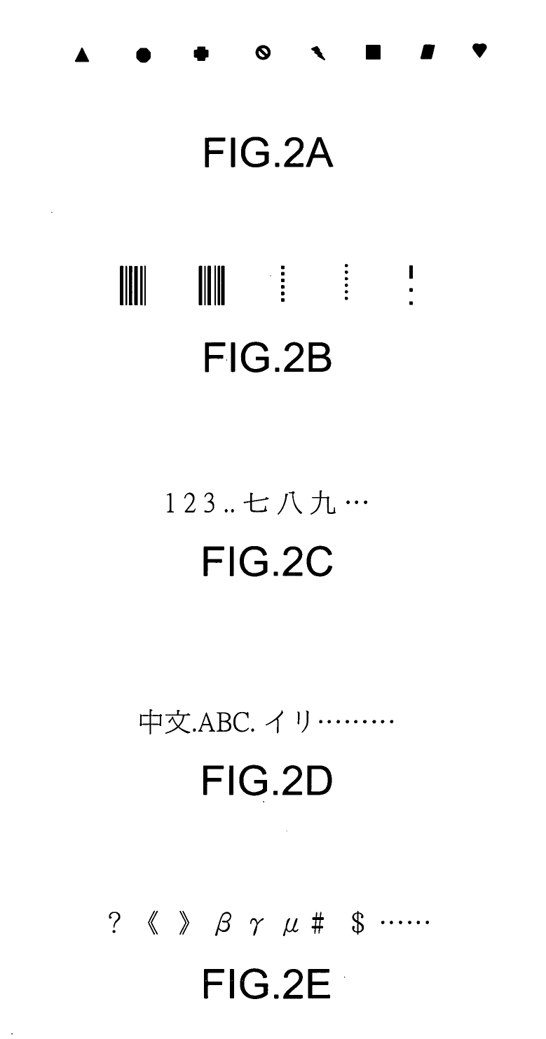

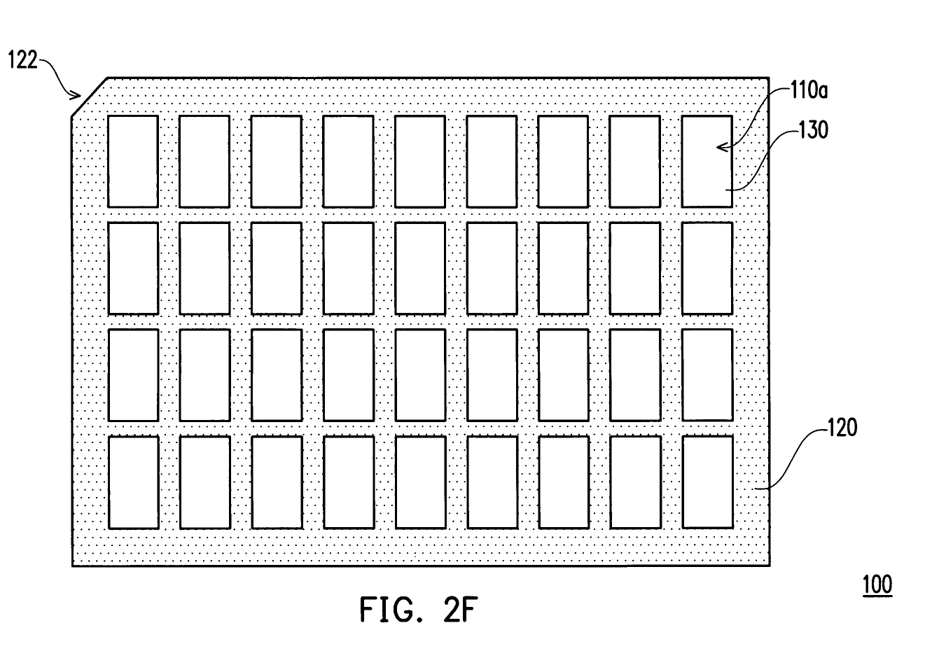

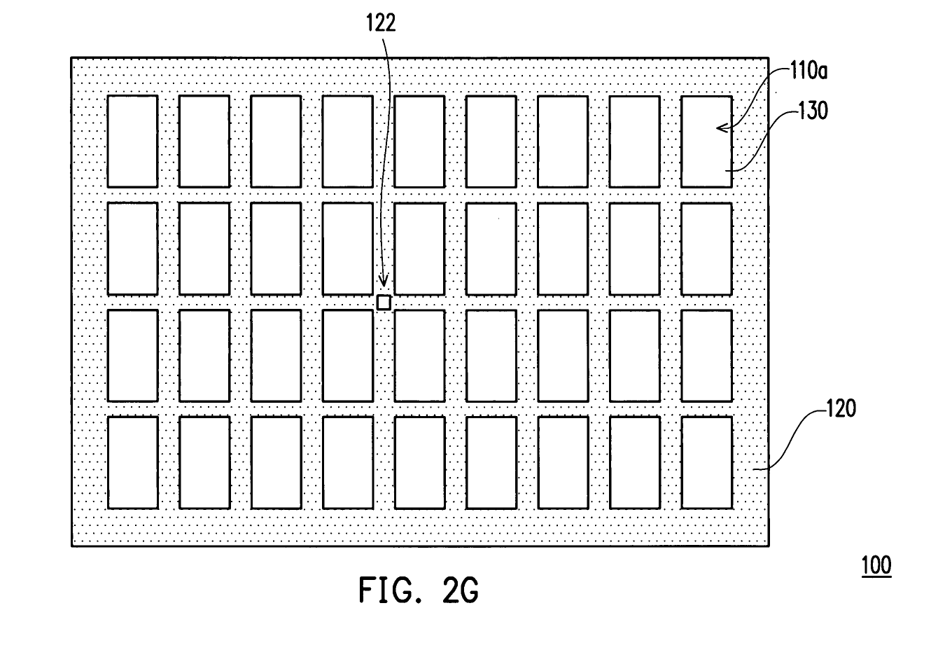

FIG. 2A-FIG. 2G are schematic diagrams of the identified mark according to the embodiment of the present invention. Referring to FIG. 2A-2G, the identified mark 122 is a pattern identified mark, such as triangle pattern, graphic pattern, cross pattern, prohibitive pattern, lightening pattern, rectangle pattern, parallelogram pattern, heart pattern, or other patterns as shown in FIG. 2A. The identified mark 122 may also be a linear barcode of different types, as shown in FIG. 2B. The identified mark 122 may also be numbers, such as Arabia number or Chinese number as shown in FIG. 2C. The identified mark 122 may also be a text, such as Chinese, English, Japanese, or other languages as shown in FIG. 2D. The identified mark 122 may also be symbol, such as a question mark, bracket mark, Roman alphabet, or other symbols as shown in FIG. 2E.

According to another embodiment, the identified mark 122 may also be the cutting angle of the black matrix layer 120, and the specific ratio of the two sides of the cutting angle can also represent the manufacturer or product model as shown in FIG. 2F. Moreover, the width of the identified mark 122 may be smaller than the width of the black matrix layer. In the embodiment, the identified mark 122 is disposed in the peripheral of the sub-pixel regions 110a (as shown in FIG. 1A), however, the identified mark 122 may also be disposed between the sub-pixel regions 110a (as shown in FIG. 2G). In other words, the present invention does not limit the location, quantity or figuration of the identified mark 122. The following will exemplify the fabricating method of the color filter substrate 100 of the embodiment; however, the fabricating method of the color filter substrate 100 of the present invention is not limited by the following method.

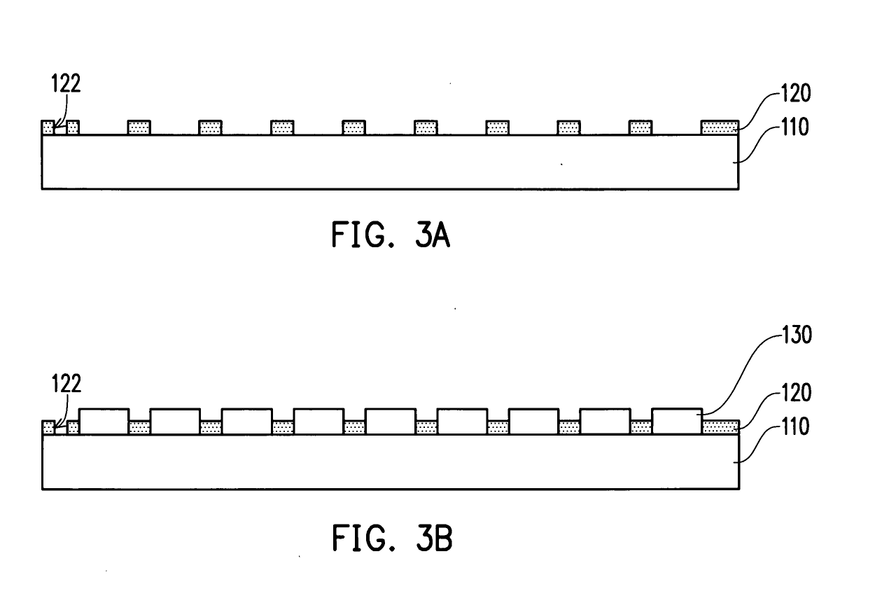

FIG. 3A and FIG. 3B are schematic cross-sectional diagrams of the fabricating method of the color filter substrate according to the embodiment of the present invention. Referring to FIG. 3A, the fabricating method of the color filter substrate of the present invention includes the following processes: first, a black matrix layer 120 is formed upon the substrate 110 to define a plurality of sub-pixel regions 110a (as shown in FIG. 1A), wherein the black matrix layer 120 includes at least one identified mark 122. In the embodiment, the process of forming the black matrix layer 120 further includes forming the identified mark 122 in the peripheral of the sub-pixel regions.

In more detail, the method of forming the black matrix layer 120 includes: first, forming a black matrix material layer (not shown) upon the substrate 110, then performing a patterning process for the black matrix material layer to form the black matrix layer 120. The forming methods of the black matrix layer 120 will be different along with the different materials of the black matrix layer 120. For example, if the material of the black matrix layer 120 is metal, the black matrix material layer may be formed by sputtering, and the patterning process includes a photolithographic process and an etching process. Or, if the material of the black matrix layer 120 is black matrix resin, the patterning process includes an exposing process and a developing process.

However, the process of forming the black matrix layer 120 may also be forming the identified mark 122 as a pattern, linear barcode, number, text, or symbol as shown in FIGS. 2A-2E. Alternatively, the forming process of the black matrix layer 120 may also be forming the identified mark 122 between the sub-pixel regions as shown in FIG. 2G.

Referring to FIG. 3B, a color pattern layer is formed in each of the sub-pixel regions 110a. If the material of the color pattern layer 130 is photoresistant, the color pattern layer 130 may be formed by performing multiple exposing and developing processes. If the material of the color pattern layer 130 is dye, the color pattern layer 130 can be formed by inkjet process. Thereafter, an electrode layer 140 is formed over the substrate 110 to cover the black matrix layer 120 and the color pattern layer 130 as shown in FIG. 1B. The forming method of the electrode layer 140 may be sputtering process.

As the black matrix layer 120 has the identified mark 122, a worker can identify the manufacturer or product model of the assembled color filter substrate by optical detecting system or eyeballing. Moreover, as the identified mark 122 is formed on the color filter substrate 100, the identified mark originally formed on the thin film transistor array substrate used for identifying the manufacturer of the color filter substrate 100 can be cancelled, so as to increase the usage area or shorten the identified mark length. In addition, compared with conventional technologies, as the identified mark 122 and the black matrix layer 120 are formed simultaneously, there is no additional fabricating process needed in the fabricating method of the color filter substrate 100 of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter substrate, comprising:
a black matrix layer, disposed on a substrate to define a plurality of sub-pixel regions thereon and at least an identified mark;
a color pattern layer, disposed in each of the sub-pixel regions; and
an electrode layer, disposed on the color pattern layer and the black matrix layer.

2. The color filter substrate as claimed in claim 1, wherein the identified mark includes a pattern, linear barcode, number, text, or symbol.

3. The color filter substrate as claimed in claim 1, wherein the width of the identified mark is smaller than the width of the black matrix layer.

4. The color filter substrate as claimed in claim 1, wherein the identified mark is the cutting angle of the black matrix layer.

5. The color filter substrate as claimed in claim 1, wherein the identified mark is disposed in the periphery of the sub-pixel regions.

6. The color filter substrate as claimed in claim 1, wherein the identified mark is disposed between the sub-pixel regions.

7. A fabricating method of the color filter substrate, comprising:
providing a substrate;
forming a black matrix layer on the substrate to define a plurality of sub-pixel regions, wherein the black matrix layer has at least an identified mark;
forming a color pattern layer in each of the sub-pixel regions; and
forming an electrode layer over the substrate to cover the black matrix layer and the color pattern layer.

8. The fabricating method of the color filter substrate as claimed in claim 7, wherein the forming process of the black matrix layer comprises:
forming a black matrix material layer on the substrate;
performing a patterning process for the black matrix material layer to form the black matrix layer.

9. The fabricating method of the color filter substrate as claimed in claim 8, wherein the patterning process comprises a photolithography process and an etching process.

10. The fabricating method of the color filter substrate as claimed in claim 8, wherein the patterning process comprises exposing process and developing process.

11. The fabricating method of the color filter substrate as claimed in claim 7, wherein the process of forming the black matrix layer further comprises forming the identified mark as a pattern, linear barcode, number, text, or symbol.

12. The fabricating method of the color filter substrate as claimed in claim 7, wherein the process of forming the black matrix layer further comprises forming the identified mark in the periphery of the sub-pixel regions.

13. The fabricating method of the color filter substrate as claimed in claim 7, wherein the process of forming the black matrix layer further comprises forming the identified mark between the sub-pixel regions.
